(19) United States
(12) Patent Application Publication
(10) Pub. No.: US 2026/0011318 A1
(43) Pub. Date: Jan. 8, 2026

(54) ACTIVE NOISE REDUCTION DEVICE, MOBILE OBJECT, AND ACTIVE NOISE REDUCTION METHOD

(71) Applicant: Panasonic Automotive Systems Co., Ltd., Kanagawa (JP)

(72) Inventor: Shotaro UENO, Osaka (JP)

(73) Assignee: Panasonic Automotive Systems Co., Ltd., Kanagawa (JP)

(21) Appl. No.: 19/254,085

(22) Filed: Jun. 30, 2025

(30) Foreign Application Priority Data
Jul. 4, 2024 (JP) 2024-108354

(51) Int. Cl. G10K 11/178

(52) U.S. Cl. CPC G10K 11/17854; G10K 11/17815; G10K 11/17857; G10K 11/17881

(57) ABSTRACT

An active noise reduction device includes a storage that stores an impulse response with a first sampling rate, the impulse response simulating a sound transfer characteristic ranging from a loudspeaker to a microphone when the adjustment state of a seat is a reference position, and a simulated sound transfer characteristic generator that generates a simulated sound transfer characteristic by acquiring the adjustment state of the seat, shifting the impulse response in a time-base direction according to the acquired adjustment state of the seat, and downsampling the shifted impulse response from the first sampling rate to a second sampling rate.

### CROSS REFERENCE TO RELATED APPLICATION

The present application is based on and claims priority of Japanese Patent Application No. 2024-108354 filed on Jul. 4, 2024.

### FIELD

The present disclosure relates to an active noise reduction device that actively reduces noise by causing interference between the noise and a cancellation sound, a mobile object including the active noise reduction device, and an active noise reduction method.

### BACKGROUND

Conventionally, there is known to be an active noise reduction device that actively reduces noise by outputting a cancellation sound for cancelling noise from a cancellation sound source by using a reference signal that correlates with the noise and an error signal that is based on a residual sound obtained by interference between the noise and the cancellation sound in a predetermined space (e.g., see Patent Literature (PTL) 1). In order to minimize the sum of squares of the error signal, the active noise reduction device generates a cancellation signal for outputting the cancellation sound by using an adaptive filter.

### CITATION LIST

### Patent Literature

PTL 1: International Publication No. WO 2014/006846
PTL 2: Japanese Unexamined Patent Application Publication No. 2019-053095

### SUMMARY

### Technical Problem

The present disclosure provides an active noise reduction device that can be improved upon.

### Solution to Problem

An active noise reduction device according to one aspect of the present disclosure is an active noise reduction device that reduces noise at a position of a microphone provided at a seat whose position or orientation is adjustable, by outputting a cancellation sound from a loudspeaker in an inner space of a mobile object. The active noise reduction device includes a storage that stores an impulse response with a first sampling rate, the impulse response simulating a sound transfer characteristic ranging from the loudspeaker to the microphone when an adjustment state of the seat is a reference position, an adaptive filter part that generates a cancellation signal that is used to output the cancellation sound, by applying an adaptive filter to a reference signal that is correlated with the noise and that is output from a reference signal source provided in the mobile object, a simulated sound transfer characteristic generator that generates a simulated sound transfer characteristic by acquiring the adjustment state of the seat relative to the position of the microphone, shifting the impulse response in a time-base direction according to the adjustment state of the seat acquired, and downsampling the impulse response shifted, from the first sampling rate to a second sampling rate, a simulated sound transfer characteristic filter part that generates a filtered reference signal by correcting the reference signal in accordance with the simulated sound transfer characteristic generated, and a filter coefficient updater that updates a coefficient of the adaptive filter by using the filtered reference signal generated and an error signal that is output from the microphone and that corresponds to a residual sound caused by interference between the noise and the cancellation sound.

### Advantageous Effects of Invention

The active noise reduction device according to one aspect of the present disclosure can be improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram of a vehicle when viewed from above, the vehicle including an active noise reduction device according to an embodiment.

FIG. 2 is a diagram showing an example of detecting a seat position by a seat position detector.

FIG. 3 is a block diagram showing a functional configuration of the active noise reduction device according to the embodiment.

FIG. 4 is a flowchart of a noise reduction operation of the active noise reduction device according to the embodiment.

FIG. 5 is a diagram for describing upsampling of an impulse response.

FIG. 6 is a diagram showing one example of a method of generating table information.

FIG. 7 is a diagram showing Example 1 of a method of generating simulated sound transfer characteristics.

FIG. 8 is a diagram showing Example 2 of the method of generating simulated sound transfer characteristics.

FIG. 9 is a diagram comprehensively showing shift amounts and sample numbers stored in the impulse response after downsampling.

FIG. 10 is a diagram showing a noise reduction effect when the adjustment state of a seat is a reference position and a cancellation sound is output by using a fixed simulated sound transfer function.

FIG. 11 is a diagram showing a noise reduction effect achieved in the case where when a backrest of the seat tilts backward, a cancellation sound is output by using a fixed simulated sound transfer function.

FIG. 12 is a diagram showing a noise reduction effect achieved in the case where when the backrest of the seat tilts backward, the cancellation sound is output by using a variable simulated sound transfer function.

FIG. 13A is a diagram showing one example of an arrangement of second loudspeakers for reducing noise in frequency bands lower than a predetermined boundary frequency.

FIG. 13B is a diagram showing one example of frequency characteristics of the second loudspeakers for reducing noise in frequency bands lower than the predetermined boundary frequency.

FIG. 14A is a diagram showing one example of an arrangement of first loudspeakers for reducing noise in frequency bands higher than or equal to the predetermined boundary frequency.

FIG. 14B is a diagram showing one example of frequency characteristics of the first loudspeakers for reducing noise in frequency bands higher than or equal to the predetermined boundary frequency.

FIG. 15 is a diagram showing one example of first table information and second table information.

FIG. 16 is a diagram for describing a predetermined range.

FIG. 17 is a block diagram showing a functional configuration of an active noise reduction device capable of reducing two types of noise.

FIG. 18 is a block diagram showing a functional configuration of a signal processor that conforms to a single-frequency adaptive notch filter (SAN) algorithm.

FIG. 19 is a diagram showing the relation between a noise signal (a sinusoidal signal of noise) and a cancellation signal according to the SAN algorithm.

FIG. 20 is a block diagram showing a functional configuration of a signal processor that conforms to a SAN Filtered-x least mean square (LMS) algorithm.

FIG. 21 is a diagram showing the relation between noise and a cancellation sound according to the SAN Filtered-x LMS algorithm.

### DESCRIPTION OF EMBODIMENTS

Embodiments are described hereinafter in greater detail with reference to the accompanying drawings. Each embodiment described below shows a general or specific example. Numerical values, shapes, materials, constituent elements, positions in the arrangement of and connection forms of the constituent elements, steps, a sequence of steps, and so on shown in the following embodiments are mere examples and do not intend to limit the scope of the present disclosure. Among constituent elements in the following exemplary embodiments, those that are not recited in any independent claim are described as optional constituent elements.

Note that each drawing is a schematic diagram and does not necessarily provide precise depiction. Substantially the same constituent elements are given the same reference signs throughout the drawings, and their detailed description may be omitted or simplified.

### Embodiment

### Configuration of Vehicle Including Active Noise Reduction Device

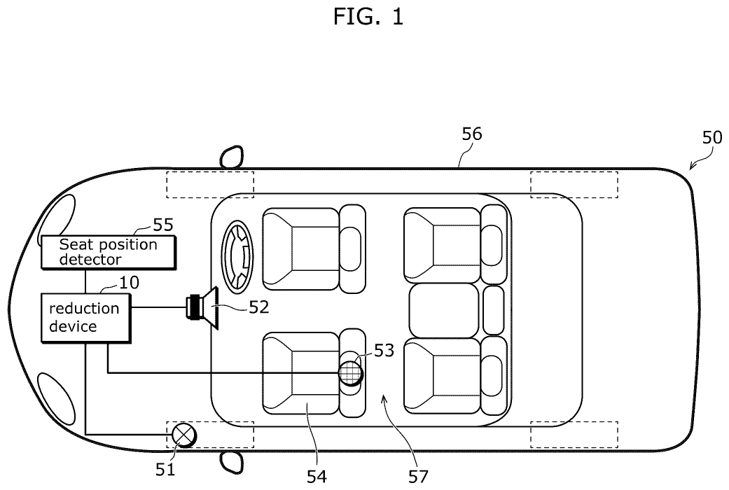

The present embodiment describes an active noise reduction device installed in a vehicle. FIG. 1 is a schematic diagram of the vehicle including the active noise reduction device according to the embodiment, when viewed from above.

Vehicle 50 is one example of a mobile object and includes active noise reduction device 10 according to the embodiment, reference signal source 51, loudspeaker 52, microphone 53, seats 54, seat position detector 55, and vehicle body 56. Vehicle 50 is specifically a gasoline-powered vehicle, but it may also be an electric vehicle (EV) or a hybrid vehicle. The hybrid vehicle as referred to herein includes a series hybrid vehicle, a parallel hybrid vehicle, and a split hybrid vehicle. The hybrid vehicle as referred to herein also includes a plug-in hybrid vehicle.

Reference signal source 51 is a transducer that outputs a reference signal correlating with noise in space 57 in the cabin of vehicle 50. For example, reference signal source 51 may be an acceleration sensor and may be arranged outside space 57. In the example shown in FIG. 1, reference signal source 51 is provided in a subframe located in the vicinity of a left front wheel or in a wheel well of the left front wheel. Note that there are no particular limitations on the attachment position of reference signal source 51. In the case where reference signal source 51 is an acceleration sensor, active noise reduction device 10 is capable of reducing road noise inside space 57. Note that reference signal source 51 may also be a microphone.

Loudspeaker 52 outputs a cancellation sound to space 57 by using a cancellation signal. Active noise reduction device 10 may use a plurality of loudspeakers 52, and there are no particular limitations on the attachment position of each loudspeaker 52.

Microphone 53 detects a residual sound caused by interference between noise and the cancellation sound inside space 57 and outputs an error signal based on the residual sound. For example, microphone 53 may be provided at a headrest of seat 54 located inside space 57. Note that vehicle 50 may include a plurality of microphones 53.

Each seat 54 is movable and has a back-and-forth position and a backrest angle (an orientation of seat 54) that are adjustable by a user. Microphone 53 is fixedly provided at the headrest of seat 54. The headrest of seat 54 may have an adjustable height, or the height of seat 54 as a whole may be adjustable.

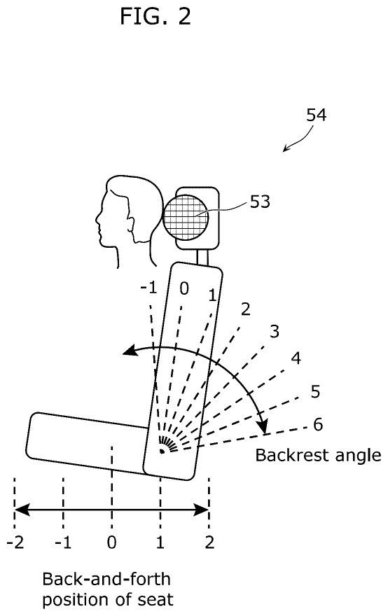

Seat position detector 55 detects the back-and-forth position and backrest angle of seat 54 (i.e., the adjustment state of seat 54) and outputs a detection signal indicating the adjustment state of seat 54. For example, seat position detector 55 may be a sensor module that senses the adjustment state of seat 54. FIG. 2 is a diagram showing an example of detecting a seat position by seat position detector 55.

As shown in FIG. 2, seat position detector 55 detects the backrest angle of seat 54 in eight tiers from −1 to +6 and also detects the back-and-forth position of seat 54 in five tiers from −2 to +2. It is defined in the following embodiment that the adjustment state of seat 54 is a reference position when the backrest angle is 0 and the back-and-forth position is 0.

Vehicle body 56 is a structure configured by, for example, the chassis and body of vehicle 50. Vehicle body 56 forms space 57 (cabin space) in which loudspeaker 52 and microphone 53 are arranged.

### Configuration of Active Noise Reduction Device

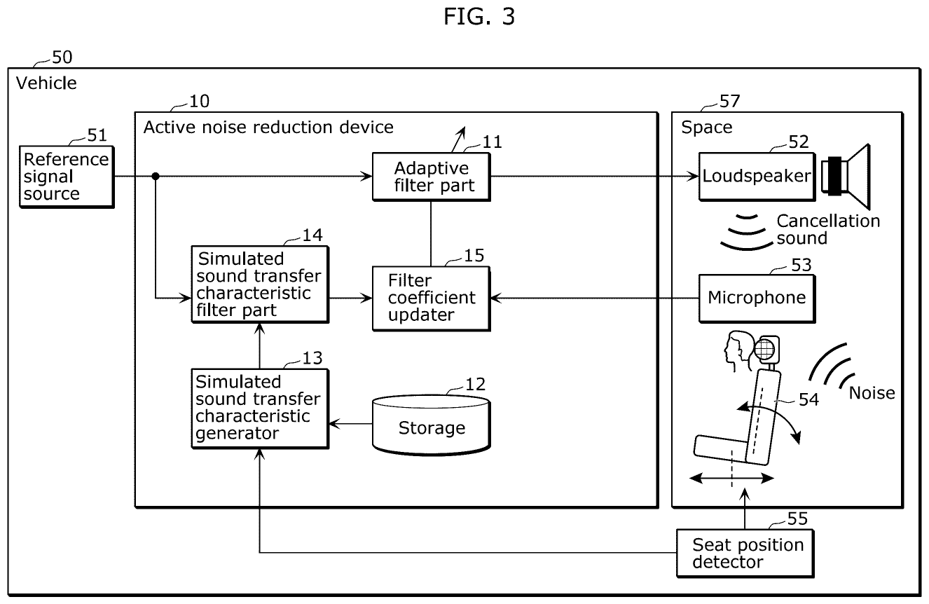

Next, a configuration of active noise reduction device 10 is described. FIG. 3 is a block diagram showing a functional configuration of active noise reduction device 10.

As shown in FIG. 3, active noise reduction device 10 includes adaptive filter part 11, storage 12, simulated sound transfer characteristic generator 13, simulated sound transfer characteristic filter part 14, and filter coefficient updater 15. For example, adaptive filter part 11, simulated sound transfer characteristic filter part 14, filter coefficient updater 15, and simulated sound transfer characteristic generator 13 may be realized by, for example, a microcomputer or a processor such as a digital signal processor (DSP) executing software. Adaptive filter part 11, simulated sound transfer characteristic generator 13, simulated sound transfer characteristic filter part 14, and filter coefficient updater 15 may also be realized by hardware such as circuits. As another alternative, some of adaptive filter part 11, simulated sound transfer characteristic generator 13, simulated sound transfer characteristic filter part 14, and filter coefficient updater 15 may be realized by software, and the others thereof may be realized by hardware.

### Noise Reduction Operation

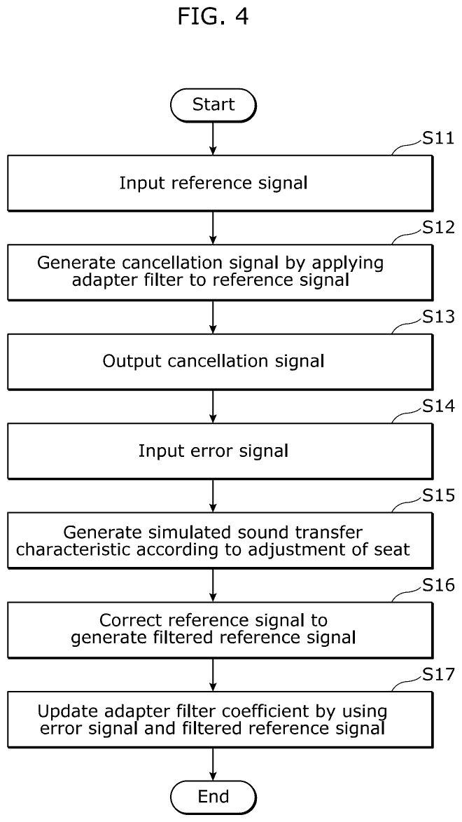

As described above, active noise reduction device 10 performs a noise reduction operation. The noise reduction operation of active noise reduction device 10 is described with reference to FIG. 4 in addition to FIG. 3. FIG. 4 is a flowchart showing the noise reduction operation of active noise reduction device 10.

First, active noise reduction device 10 receives input of a reference signal correlating with noise from reference signal source 51 (S11).

The reference signal input to active noise reduction device 10 is output to adaptive filter part 11 and simulated sound transfer characteristic filter part 14.

Adaptive filter part 11 generates a cancellation signal by applying an adaptive filter to the reference signal (convolution) (S12). Adaptive filter part 11 is realized by a so-called FIR or IIR filter. The cancellation signal generated by adaptive filter part 11 is output to loudspeaker 52 (S13). Loudspeaker 52 outputs a cancellation sound based on the cancellation signal.

Microphone 53 detects a residual sound caused by interference between noise and the cancellation sound output from loudspeaker 52 and outputs an error signal corresponding to the residual sound. In other words, the error signal is a signal that indicates the state of noise inside space 57 of vehicle 50 when the cancellation sound is output. As a result, the error signal is input to active noise reduction device 10 (S14). The error signal input to active noise reduction device 10 is output to filter coefficient updater 15.

Here, storage 12 stores an impulse response with a first sampling rate, the impulse response simulating a sound transfer characteristic measured in advance inside space 57 of vehicle 50. To be more specific, the impulse response is first measured with a second sampling rate lower than the first sampling rate and is then upsampled and stored with the first sampling rate in storage 12.

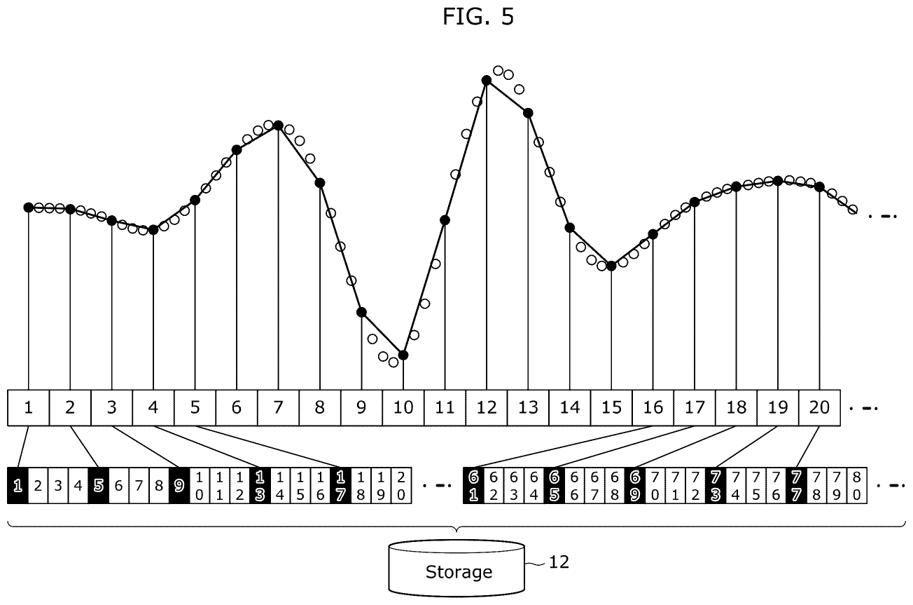

FIG. 5 is a diagram for describing the upsampling of the impulse response. In the example shown in FIG. 5, measured points are indicated in black, and points interpolated by the upsampling are indicated in white. Specifically, the upsampling to the first sampling rate (the interpolation of white dots) is implemented by interpolating zeros into the space between each pair of measured points and applying a predetermined low-pass filter to a signal interpolated with zeros. For example, the first sampling rate may be four times the second sampling rate, and if the number of taps for representing an impulse response is assumed to be 20 as shown in FIG. 5, storage 12 stores the impulse response represented with 80 points which is four times the number of taps.

Simulated sound transfer characteristic generator 13 generates a simulated sound transfer characteristic by correcting the impulse response stored in storage 12 (S15). Specifically, simulated sound transfer characteristic generator 13 acquires a detection signal (i.e., the adjustment state of seat 54) that is output from seat position detector 55 and shifts the impulse response in a time-base direction according to the adjustment state of seat 54 indicated by the acquired detection signal. Simulated sound transfer characteristic generator 13 further generates a simulated sound transfer characteristic by downsampling the shifted impulse response from the first sampling rate to the second sampling rate. The simulated sound transfer characteristic refers to a transfer characteristic that simulates a sound transfer characteristic ranging from the position of loudspeaker 52 to the position of microphone 53 (i.e., a sound transfer characteristic inside space 57 of vehicle 50). In the case where the adjustment state of seat 54 is a reference position, the impulse response is not shifted in the time-base direction and only downsampling is performed. Details of the processing performed in step S15 will be described later.

Simulated sound transfer characteristic filter part 14 generates a filtered reference signal by correcting the reference signal with use of the generated simulated sound transfer characteristic (S16). Simulated sound transfer characteristic filter part 14 generates the filtered reference signal through convolution using the reference signal and the simulated sound transfer characteristic.

Filter coefficient updater 15 updates coefficient W of the adaptive filter in succession in accordance with the error signal and the generated filtered reference signal (S17).

Specifically, filter coefficient updater 15 calculates the coefficient of the adaptive filter so as to minimize the sum of squares of the error signal by using a least mean square (LMS) method and outputs calculated coefficient W of the adaptive filter to adaptive filter part 11. Filter coefficient updater 15 also updates coefficient W of the adaptive filter in succession. When the error signal is expressed as e and the filtered reference signal is expressed as R, coefficient W of the adaptive filter is expressed by the following mathematical expression, where n is a natural number, and sampling cycle Ts represents the n-th sampling. Also, u denotes the scalar quantity and indicates the step size parameter that determines the amount of update of coefficient W of the adaptive filter per sampling unit.

$$W ( n + 1 ) = W ( n ) - μ e ( n ) R ( n ) \qquad [ Math . 1 ]$$

As described above, active noise reduction device 10 can generate the cancellation signal by applying the adaptive filter whose coefficient is updated based on the error signal, to the reference signal. When the cancellation sound is output based on the cancellation signal by loudspeaker 52, noise inside space 57 is reduced.

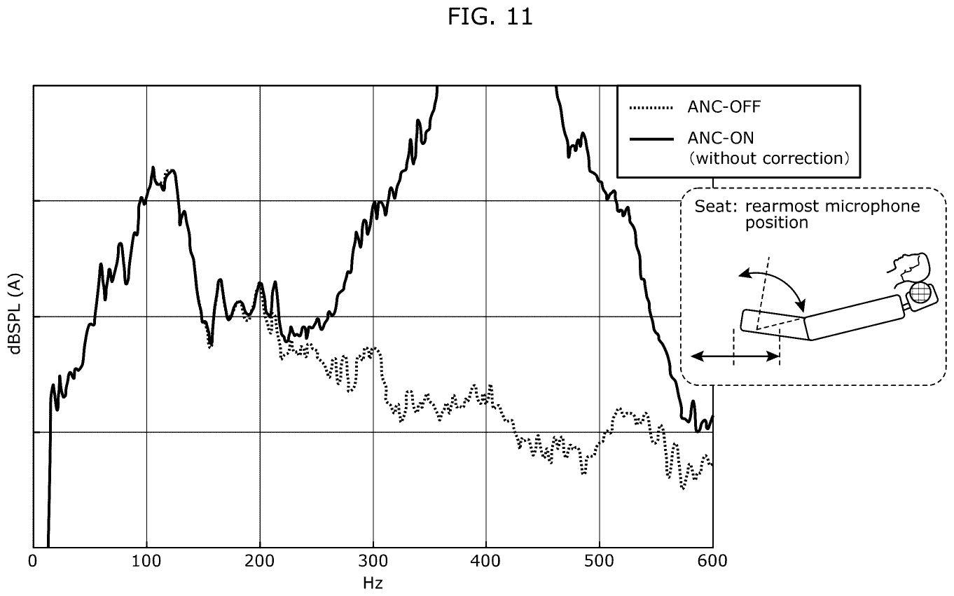

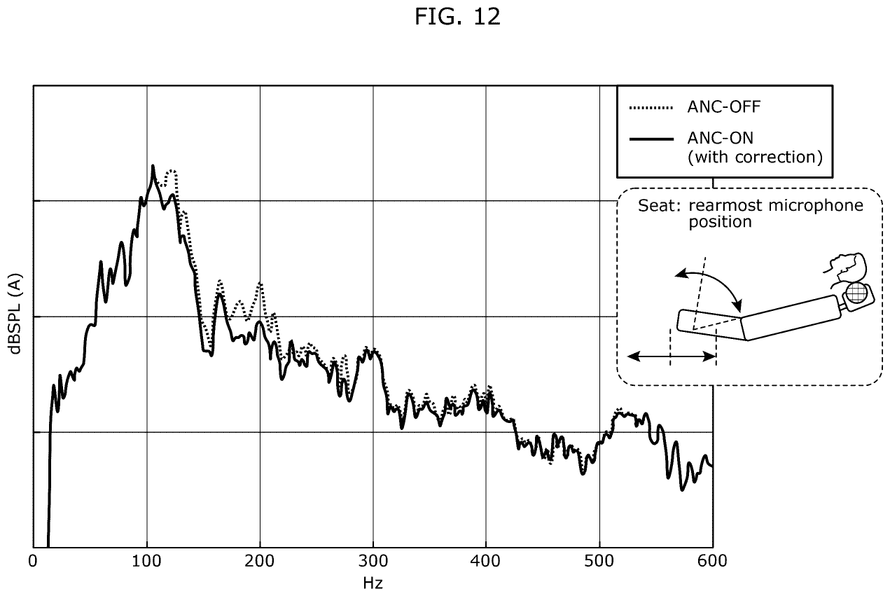

In step S15 described above, active noise reduction device 10 can generate the simulated sound transfer characteristic in consideration of the adjustment state of seat 54 (i.e., the sound transfer characteristic) by shifting the impulse response in the time-base direction according to the adjustment state of seat 54 indicated by the detection signal. This improves noise reduction performance. The effect of improving noise reduction performance will be described later with reference to FIGS. 11 and 12.

### Overview of Method of Generating Simulated Sound Transfer Characteristic

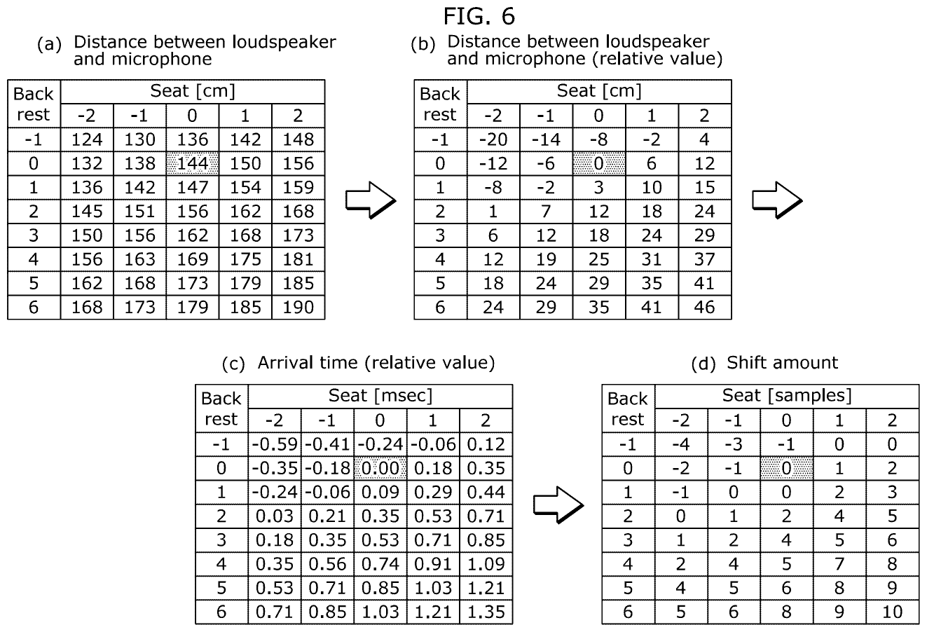

In order to shift the impulse response in the time-base direction according to the adjustment state of seat 54 indicated by the detection signal in step S15 described above, storage 12 stores, in advance, table information that associates the adjustment state of seat 54 with the shift amount. Hereinafter, a method of generating the table information is described. FIG. 6 is a diagram showing one example of the method of generating the table information.

In (a) to (d) in FIG. 6, the rows of each matrix of the table information denote the back-and-forth position (−2 to +2) of seat 54, and the columns of the matrix denote the backrest angle (−1 to +6) of seat 54.

Designers or the like of active noise reduction device 10 first obtain the distance from loudspeaker 52 to microphone 53 for each adjustment state of seat 54 by actual measurement ((a) in FIG. 6). Then, the designers or the like translate the distance from loudspeaker 52 to microphone 53 for each adjustment state of seat 54 into a value relative to the distance obtained when the back-and-forth position of seat 54 is 0 and the backrest angle of seat 54 is 0 ((b) in FIG. 6).

Then, the designers or the like translate the distance (relative value) from loudspeaker 52 to microphone 53 for each adjustment state of seat 54 into the arrival time of sound (relative value) by dividing the distance by the velocity of sound (340 m/s) ((c) in FIG. 6). Ultimately, the designers or the like translate the arrival time of sound (relative value) from loudspeaker 52 to microphone 53 for each adjustment state of seat 54 into the number of samples at the first sampling rate ((d) in FIG. 6). In this way, the table information that associates each adjustment state of seat 54 with the shift amount (the number of samples) is generated.

### Specific Example of Method of Generating Simulated Sound Transfer Characteristic

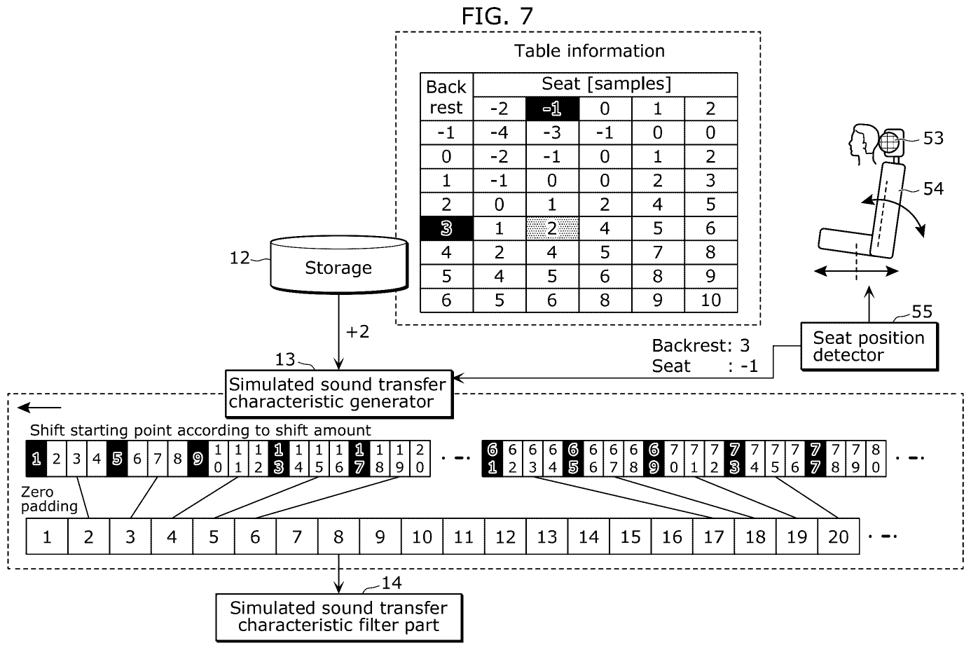

Next description is given regarding a specific method of generating the simulated sound transfer characteristic by using the table information shown in FIG. 6. FIG. 7 is a diagram showing Example 1 of the method of generating the simulated sound transfer characteristic. The following description assumes that samples of the impulse response with the first sampling rate stored in storage 12 are assigned numbers (indices) from 1 to 80, and taps of the impulse responses after downsampling (the simulated sound transfer characteristic) are assigned numbers (indices) from 1 to 20.

When the adjustment state of the seat is a reference position, sample numbers 1, 5, 9, . . . , and 77 are stored in taps 1 to 20.

For example, in the case where the detection signal acquired from seat position detector 55 indicates that the backrest angle of seat 54 is 3 and the back-and-forth position of seat 54 is −1, simulated sound transfer characteristic generator 13 can identify the shift amount as +2 in accordance with the table information stored in storage 12.

If the shift amount is positive, the phase of the impulse response delays behind the phase of the impulse obtained when the adjustment state of the seat is the reference position. In view of this, simulated sound transfer characteristic generator 13 generates the simulated sound transfer characteristic by interpolating zeros into tap 1 and storing sample numbers 3, 7, 11, . . . , and 75 in taps 2 to 20.

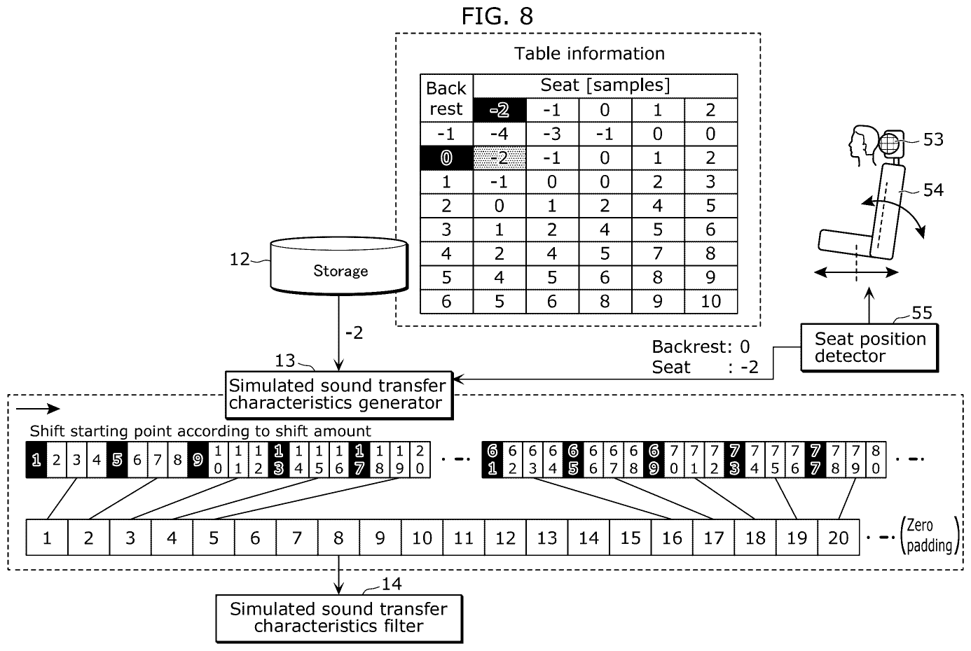

FIG. 8 is a diagram showing Example 2 of the method of generating the simulated sound transfer characteristic. In the case where the detection signal acquired from seat position detector 55 indicates that the backrest angle of seat 54 is 0 and the back-and-forth position of seat 54 is −2, simulated sound transfer characteristic generator 13 can identify the shift amount as −2 in accordance with the table information stored in storage 12.

If the shift amount is negative, the phase of the impulse response advances ahead of the phase of the impulse response obtained when the adjustment state of the seat is the reference position. In view of this, simulated sound transfer characteristic generator 13 generates the simulated sound transfer characteristic by storing sample numbers 3, 7, 11, . . . , and 79 in taps 1 to 20.

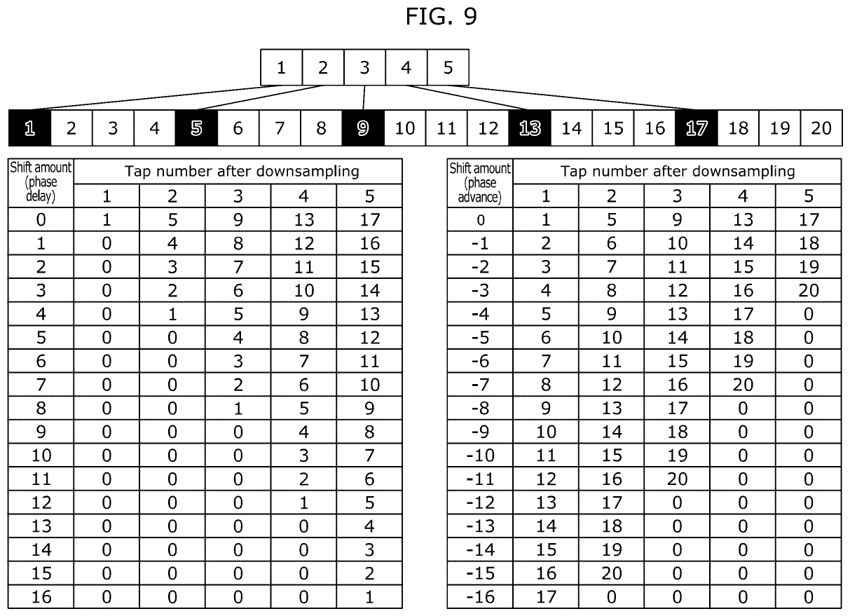

FIG. 9 is a diagram comprehensively showing the shift amount and the sample number stored in the impulse response after downsampling. In the example shown in FIG. 9, samples of the impulse response with the first sampling rate, stored in storage 12, are assigned numbers from 1 to 20, and taps of the impulse response after downsampling (simulated sound transfer characteristic) are assigned numbers from 1 to 5.

### Noise Reduction Effect

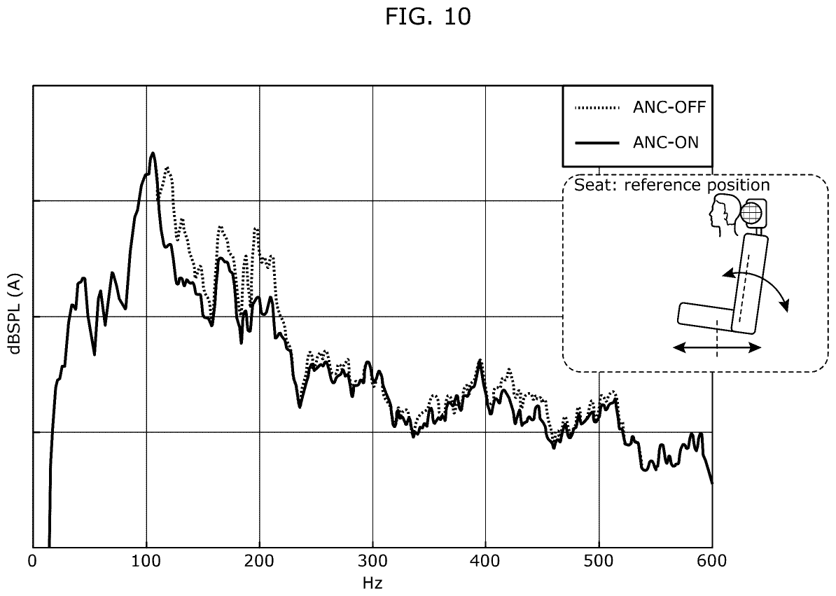

Next description is given regarding a noise reduction effect produced by shifting the impulse response according to the adjustment state of seat 54 to generate the simulated sound transfer characteristic in step S15. First, as a comparative example, description is given regarding a noise reduction effect produced when a fixed simulated sound transfer characteristic (impulse response) is used while the adjustment state of seat 54 is assumed to be the reference position. FIG. 10 is a diagram showing a noise level (ANC-OFF) when the cancellation sound is not output, and a noise level (ANC-ON) when the cancellation sound is output by using the fixed simulated sound transfer function while the adjustment state of seat 54 is assumed to be the reference position. FIG. 11 is a diagram showing a noise level (ANC-OFF) when the cancellation sound is not output, and a noise level (ANC-ON) when the cancellation sound is output by using the fixed simulated sound transfer function while the backrest angle of seat 54 is assumed to be +6 and the back-and-forth position of seat 54 is assumed to be +2. In FIGS. 10 and 11 and FIG. 12 which will be described later, each tick mark on the vertical axis is equivalent to 10 dB.

As shown in FIGS. 10 and 11, in the case of using the fixed simulated sound transfer characteristic, active noise reduction device 10 can reduce noise when the adjustment state of seat 54 is the reference position (see FIG. 10), but cannot reduce noise when the distance from loudspeaker 52 to microphone 53 is considerably different from that in the case where the adjustment state of the seat is the reference position (FIG. 11).

In contrast, FIG. 12 is a diagram showing a noise level (ANC-OFF) when the cancellation sound is not output, and a noise level (ANC-ON) when the cancelation sound is output by using the simulated sound transfer characteristic generated by shifting the impulse response according to the adjustment state of seat 54 while the backrest angle of seat 54 is assumed to be 6 and the back-and-forth position of seat 54 is assumed to be +2.

As shown in FIG. 12, even if the distance from loudspeaker 52 to microphone 53 is considerably different from that in the case where the adjustment state of the seat is the reference position, active noise reduction device 10 can reduce noise by outputting the cancellation sound with use of the simulated sound transfer characteristic generated by shifting the impulse response according to the adjustment state of seat 54 (hereinafter, also referred to as a “variable simulated sound transfer characteristic”). That is, the use of the simulated sound transfer characteristic according to the adjustment state of seat 54 allows active noise reduction device 10 to improve the stability of noise control.

### Concurrent Use of Fixed Simulated Sound Transfer Characteristic and Variable Simulated Sound Transfer Function

To simplify the description, the above-described embodiment is described assuming that one loudspeaker 52 is provided. However, vehicle 50 may include a plurality of loudspeakers 52. In the case where vehicle 50 includes a plurality of loudspeakers 52, active noise reduction device 10 may output a cancellation sound from some of loudspeakers 52 by using a fixed simulated sound transfer characteristic and may output a cancellation sound from other loudspeakers 52 by using a variable simulated sound transfer characteristic.

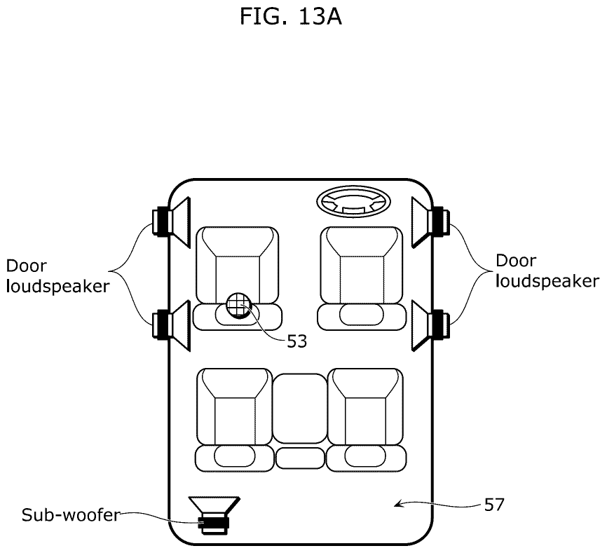

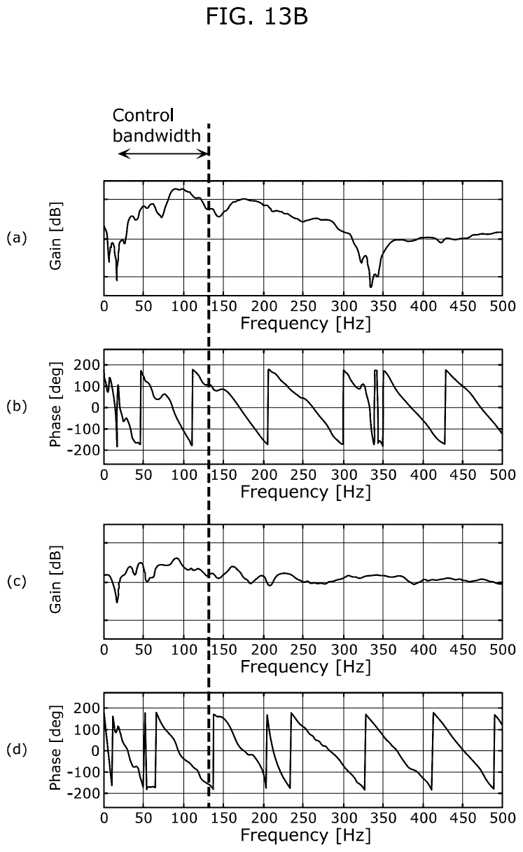

For example, active noise reduction device 10 may use a fixed simulated sound transfer characteristic to output a cancellation sound from loudspeakers 52 for reducing noise in frequency bands lower than a predetermined boundary frequency (these loudspeakers are hereinafter also referred to as “second loudspeakers”). FIG. 13A is a diagram showing one example of the arrangement of the second loudspeakers for reducing noise in the frequency bands lower than the predetermined boundary frequency. The second loudspeakers include door loudspeakers and a sub-woofer.

FIG. 13B is a diagram showing one example of frequency characteristics of the second loudspeakers. Here, (a) in FIG. 13B is a diagram showing the frequency characteristic of the gain of the door loudspeakers, and (b) in FIG. 13B is a diagram showing the frequency characteristic of the phase of the door loudspeakers. Also, (c) in FIG. 13B is a diagram showing the frequency characteristic of the gain of the sub-woofer, and (d) in FIG. 13B is a diagram showing the frequency characteristic of the phase of the sub-woofer. In (a) and (c) in FIG. 13B, each tick mark on the vertical axis is equivalent to 20 dB.

For example, it is desirable that the boundary frequency may be defined as a predetermined value that falls within a range higher than or equal to 90 Hz and lower than or equal to 150 Hz. More desirably, the boundary frequency may be defined as a predetermined value that falls within a range higher than or equal to 110 Hz and lower than or equal to 130 Hz, and most desirably the boundary frequency may be defined as 125 Hz. For the second loudspeakers and for functional constituent elements that allow the second loudspeakers to output the cancellation sound, various types of parameters are designed in order to tolerate changes in the sound transfer characteristic caused by variations in the adjustment state of seat 54.

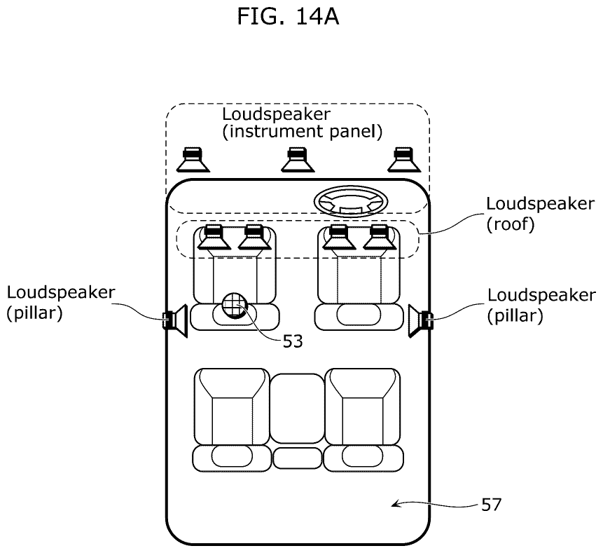

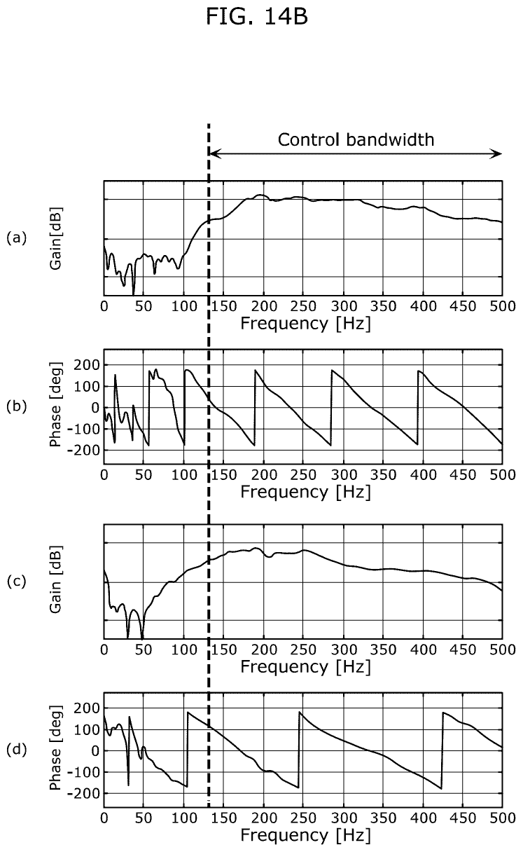

On the other hand, active noise reduction device 10 may use a variable simulated sound transfer characteristic to output a cancellation sound from loudspeakers 52 for reducing noise in frequency bands higher than or equal to the predetermined boundary frequency (these loudspeakers are hereinafter also referred to as “first loudspeakers”). FIG. 14A is a diagram showing one example of the arrangement of the first loudspeakers for reducing noise in the frequency bands higher than or equal to the predetermined boundary frequency. The first loudspeakers include loudspeakers provided in an instrumental panel and a roof and loudspeakers provided in pillars.

FIG. 14B is a diagram showing one example of frequency characteristics of the first loudspeakers. Here, (a) in FIG. 14B is a diagram showing the frequency characteristic of the gain of the loudspeaker provided in the instrumental panel, and (b) in FIG. 14B is a diagram showing the frequency characteristic of the phase of the loudspeaker provided in the instrumental panel. Also, (c) in FIG. 14B is a diagram showing the frequency characteristic of the gain of the loudspeakers provided in the pillars, and (d) in FIG. 14B is a diagram showing the frequency characteristic of the phase of the loudspeakers provided in the pillars. In (a) and (c) in FIG. 14B, each tick mark on the vertical axis is equivalent to 20 dB.

For the first loudspeakers, the influence of direct sound on the frequency characteristic of the gain is dominant, and with this frequency characteristic, it is desirable that the gain may change appropriately linearly with a change in distance from the first loudspeakers to microphone 53, and there may be a small number of dips.

In this way, active noise reduction device 10 uses the fixed simulated sound transfer characteristic c to output the cancellation sound from the second loudspeakers, and uses the variable simulated sound transfer characteristic to output the cancellation sound from the first loudspeakers. This allows efficient noise reduction.

### Gain Correction

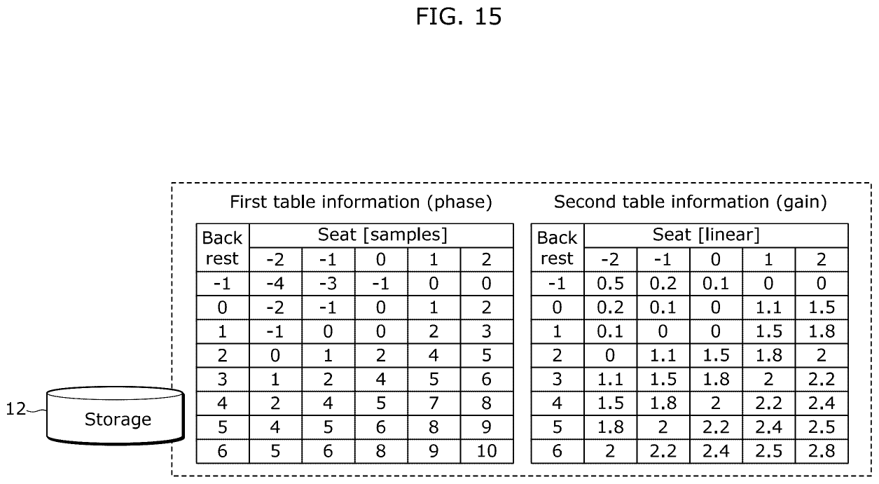

Although in the above-described embodiment, the simulated sound transfer characteristic is generated by correcting the phase of the impulse response, the simulated sound transfer characteristic may be generated by correcting the phase and gain of the impulse response. In this case, storage 12 may store table information that indicates the relation between the gain and the adjustment state of seat 54 (hereinafter, this table information is also referred to as “second table information”), in addition to the table information in (d) in FIG. 6 that indicates the relation between the adjustment state of seat 54 and the shift amount of the phase (hereinafter, this information is also referred to as “first table information”). FIG. 15 is a diagram showing one example of the first table information and the second table information.

In this case, simulated sound transfer characteristic generator 13 first shifts the impulse response in the time-base direction by a shift amount that is determined based on the first table information and the acquired adjustment state of seat 54. Simulated sound transfer characteristic generator 13 downsamples the shifted impulse response from the first sampling rate to the second sampling rate and multiples the downsampled impulse response by a gain that is determined based on the second table information and the acquired adjustment state of seat 54 so as to generate a simulated sound transfer characteristic. Note that the second sampling rate corresponds to the operating frequency of active noise reduction device 10.

In this way, active noise reduction device 10 generates the simulated sound transfer characteristic by correcting the phase and gain of the impulse response. This improves noise reduction performance as compared with the case where the simulated sound transfer characteristic is generated by correcting only the phase of the impulse response.

### Example of Processing for Stopping Output of Cancellation Sound

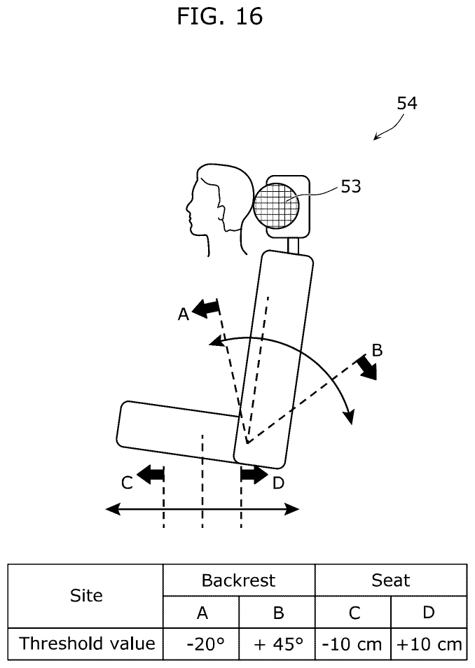

In the case where the adjustment state of seat 54 indicated by the detection signal acquired from seat position detector 55 deviates from a predetermined range, active noise reduction device 10 may stop the output of the cancellation sound. FIG. 16 is a diagram for describing the predetermined range.

As shown in FIG. 16, the predetermined range is set for each of the backrest angle and the back-and-forth position of seat 54. For example, in the case where the backrest angle of the seat at the reference position is zero and the angle at which the backrest of the seat tilts backward is a positive angle, the predetermined range for the backrest angle may be greater than or equal to −20° and less than or equal to +45°. As indicated by arrows in FIG. 16, “the backrest angle deviates from the predetermined range” means that the backrest angle is smaller than −20° (A in FIG. 16) or greater than +45° (B in FIG. 16).

For example, in the case where the back-and-forth position of the seat at the reference position is 0 and the shift amount by which seat 54 is shifted backward is a positive value, the predetermined range for the back-and-forth position of seat 54 may be a range greater than or equal to −10 cm and less than or equal to +10 cm. As indicated by arrows in FIG. 16, “the back-and-forth position of seat 54 deviates from the predetermined range means that the amount of shift of the seat from the reference position is smaller than −10 cm (C in FIG. 16) or greater than +10 cm (D in FIG. 16).

In the case where at least one of the back-and-forth position or the back-and-forth position of seat 54 deviates from the predetermined range, active noise reduction device 10 stops the output of the cancellation sound. For example, active noise reduction device 10 may stop the updating of the coefficient of the adaptive filter by filter coefficient updater 15 and may fix the coefficient of the adaptive filter used by adaptive filter part 11. Then, active noise reduction device 10 may cause the cancellation sound (cancellation signal) to fade out.

Active noise reduction device 10 as described above stops the output of the cancellation sound when the adjustment state of seat 54 deviates from the assumed range and a change in the sound transfer characteristic is expected to be greater than the assumed change. This reduces the possibility that the cancellation sound may become an unusual sound (become unable to control noise as shown in FIG. 11).

In the case where vehicle 50 includes a plurality of loudspeakers 52 as described above and at least one of the backrest angle or the back-and-forth position of seat 54 deviates from the predetermined range, active noise reduction device 10 may stop the output of the cancellation sound from all of loudspeakers 5, or may stop the output of the cancellation sound from the first loudspeakers out of loudspeakers 52 and continue to output the cancellation sound from the second loudspeakers. In the case where vehicle 50 includes a plurality of loudspeakers 52, a different predetermined range may be defined for each loudspeaker.

### Example of Processing for Limiting Output of Cancellation Sound

In the case where the adjustment state of seat 54 indicated by the detection signal acquired from seat position detector 55 deviates from the predetermined range, active noise reduction device 10 may limit the output of the cancellation sound.

An example of the predetermined range is the same as described with reference to FIG. 16, and detailed description thereof shall be omitted. Active noise reduction device 10 limits the output of the cancellation sound when at least one of the backrest angle or the back-and-forth position of seat 54 deviates from the predetermined range.

For example, active noise reduction device 10 may stop the updating of the coefficient of the adaptive filter by filter coefficient updater 15 and may fix the coefficient of the adaptive filter used by adaptive filter part 11. Then, active noise reduction device 10 may damp the amplitude of the cancellation signal down to a set value by multiplying the cancellation signal by the coefficient.

Active noise reduction device 10 as described above can reduce the possibility that the cancellation sound may become an unusual sound (become unable to control noise as shown in FIG. 11) by limiting the output of the cancellation sound when the adjustment state of seat 54 deviates from the assumed range and a change in the sound transfer characteristic is expected to be greater than the assumed change.

In the case where vehicle 50 includes a plurality of loudspeakers 52 as described above and where at least one of the backrest angle or the back-and-forth position of seat 54 deviates from the predetermined range, active noise reduction device 10 may limit the output of the cancellation sound from all of loudspeakers 52, or may limit the output of the cancellation sound from the first loudspeakers among loudspeakers 52 without limiting the output of the cancellation sound from the second loudspeakers. In the case where vehicle 50 includes a plurality of loudspeakers 52, a different predetermined value and a different set value may be defined for each loudspeaker.

### Variation of Table Information

In the above-described embodiment, the table information defines the shift amount or the gain according to the backrest angle of seat 54 and the back-and-forth position of seat 54. Here, the table information may define the shift amount or the gain according to the height of seat 54, in addition to the backrest angle of seat 54 and the back-and-forth position of seat 54. The height of seat 54 as used herein refers to the height of a headrest provided with microphone 53.

Alternatively, the table information may define the shift amount or the gain according to at least one of the backrest angle of seat 54, the back-and-forth position of seat 54, or the height of seat 54. That is, the adjustment state of seat 54 indicated by the detection signal output from seat position detector 55 may include at least one of the adjustment state of the backrest angle of seat 54, the adjustment state of the back-and-forth position of seat 54, or the adjustment state of the height of seat 54.

Method of Generating Simulated Sound Transfer Characteristic without Using Table Information

In the above-described embodiment, it is not essential to use the table information to generate the simulated sound transfer characteristic. For example, if three-dimensional coordinates are set in space 57 and three-dimensional coordinates indicating the installation position of loudspeaker 52 and three-dimensional coordinates indicating the installation position of microphone 53 are stored in storage 12, simulated sound transfer characteristic generator 13 can calculate the distance from loudspeaker 52 to microphone 53 (a relative distance assuming that the distance with the seat located at the reference position is zero) in accordance with the adjustment state of seat 54 and calculating the shift amount based on the calculated distance in the same manner as described in the technique disclosed in PTL 2. That is, simulated sound transfer characteristic generator 13 may generate the simulated sound transfer characteristic in accordance with an algorithm, instead of by the method using the table information.

### Configuration of Active Noise Reduction Device Using SAN Algorithm

Noise control targeted for road noise or the like realized by adaptive filter part 11, storage 12, simulated sound transfer characteristic generator 13, simulated sound transfer characteristic filter part 14, and filter coefficient updater 15 may also be called, for example, noise control based on a filtered-X LMS algorithm. LMS stands for Least Mean Square.

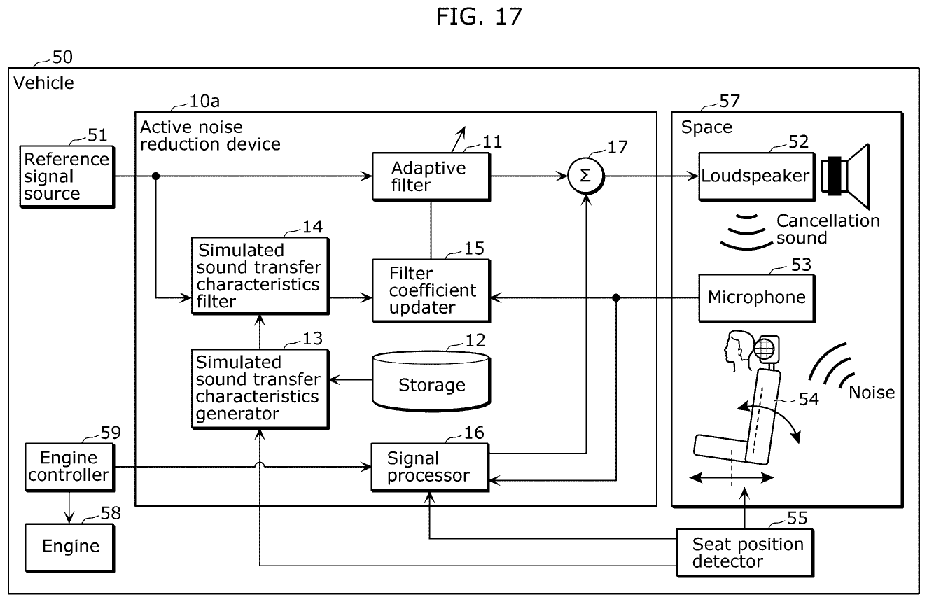

Active noise reduction device 10 may combine noise control that is based on the filtered-X LMS algorithm and targeted for road noise or the like (hereinafter, also referred to as “first noise”) and noise control that is based on a SAN filtered-x LMS algorithm and targeted for muffled engine sound or the like (hereinafter, also referred to as “second noise”). SAN stands for Single Frequency Adaptive Notch Filter. FIG. 17 is a block diagram showing a functional configuration of an active noise reduction device capable of reducing such two types of noise.

Vehicle 50 shown in FIG. 17 includes engine 58 and engine controller 59 in addition to reference signal source 51, loudspeaker 52, microphone 53, seat 54, seat position detector 55, and vehicle body 56.

Engine 58 is a power source of vehicle 50 and is also a driving device serving as a noise source inside space 57. For example, engine 58 may be arranged in another space different from space 57.

Engine controller 59 controls (drives) engine 58 in accordance with an acceleration operation or the like performed by the driver of vehicle 50. Engine controller 59 also outputs a pulse signal (engine pulse signal) that depends on the number of revolutions (frequency) of engine 58 as a second reference signal. For example, the frequency of the pulse signal may be proportional to the number of revolutions (frequency) of engine 58. The pulse signal is specifically an output signal of a top dead center (TDC) or a so-called tacho pulse. Note that engine controller 59 is one example of a second reference signal source different from reference signal source 51 (first reference signal source).

Active noise reduction device 10a shown in FIG. 17 further includes signal processor 16 and adder 17 in addition to the constituent elements of active noise reduction device 10.

Signal processor 16 performs signal processing for reducing the second noise based on the sound of engine 58. The second noise as used herein refers to, for example, muffled sound based on the sound of engine 58. The second noise is a sound that is instantaneously approximate to a sinusoidal wave with a single frequency. In view of this, signal processor 16 acquires a reference signal indicating the frequency of engine 58 from engine controller 59 that controls engine 58, and outputs a cancellation sound for reducing the second noise from loudspeaker 52. The generation of the cancellation sound uses an adaptive filter, and the cancellation sound is generated so as to reduce the residual sound acquired by microphone 53.

Adder 17 adds the cancellation signal output from adaptive filter part 11 and the cancellation signal output from signal processor 16 and outputs a resultant cancellation signal to loudspeaker 52. For example, adder 17 may be realized by a microcomputer or a processor such as a DSP executing software, or may be realized by an adding circuit that uses an operational amplifier or the like.

### Noise Reduction Method Using SAN Algorithm

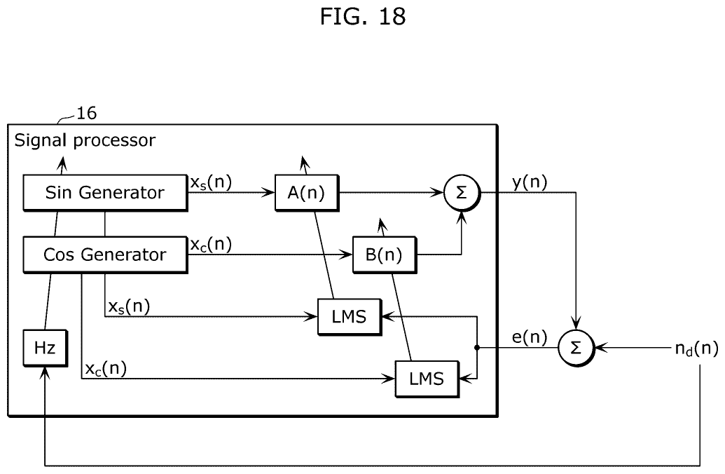

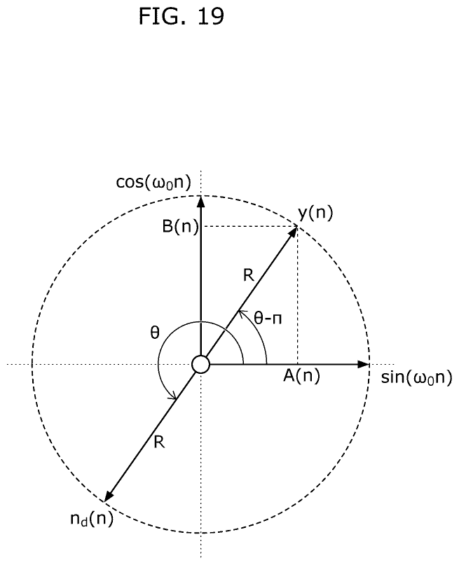

Before description of a noise reduction method using the SAN filtered-x LMS algorithm, a noise reduction method using the SAN algorithm is described as a precondition. FIG. 18 is a block diagram showing a functional configuration of signal processor 16 that conforms to the SAN algorithm. FIG. 19 is a diagram showing the relation between the noise signal (the sinusoidal signal of the second noise) and the cancellation signal in the SAN algorithm. In the noise reduction method using the SAN algorithm described below, the noise signal is described as a sinusoidal signal with a single frequency.

In FIGS. 18 and 19, n is an integer greater than or equal to zero and indicates the sampling number in a discrete time system. Normalized angular frequency ω0 [rad] is expressed by Expression 1 below, where f₀ [Hz] denotes the frequency of the noise signal to be reduced.

$${ω}_{0} = 2 π {f}_{0} {T}_{S} = 2 π {f}_{0} / {f}_{S} \qquad [ Expression 1 ]$$

In Expression 1, Tₛ[sec] denotes the sampling cycle, and fₛ[Hz] denotes the sampling frequency. By using normalized angular frequency ω₀, nTₛ that represents the discrete time is expressed by n.

Sinusoidal signal n_{d}(n) of the second noise is expressed by Expression 2 below by using normalized angular frequency ω₀, amplitude R, and phase θ [rad].

$${n}_{d} ( n ) = R sin ( {ω}_{0} n + θ ) \qquad [ Expression 2 ]$$

A cancellation signal is generated in order to reduce n_{d}(n). Cancellation signal y(n) is expressed by Expression 3 below because it has the same amplitude as n_{d}(n) and is opposite in phase to n_{d}(n).

$$\begin{matrix}y ( n ) = R sin \{ {ω}_{0} n + ( θ - π ) \} \\ = A ( n ) sin ( {ω}_{0} n ) + B ( n ) cos ( {ω}_{0} n )\end{matrix} \qquad [ Expression 3 ]$$

A(n) and B(n) are filter coefficients of the adaptive filter. Amplitude R of cancellation signal y(n) is expressed as the root square of A(n)²+B(n)², and phase (θ−n) is expressed as the inverse tangent of B(n)/A(n). Thus, the amplitude of the cancellation signal is changed by changing the magnitudes of filter coefficients A(n) and B(n) of the adaptive filter, and the phase of the cancellation signal is changed by changing the ratio of filter coefficients A(n) and B(n) of the adaptive filter.

Here, filter coefficients A(n) and B(n) of the adaptive filter are optimized by the LMS algorithm so as to minimize e(n), where e(n) denotes the error signal caused by interference between the noise signal and the cancellation signal. Accordingly, the noise signal is reduced.

### Noise Reduction Method Using SAN Filtered-x LMS Algorithm

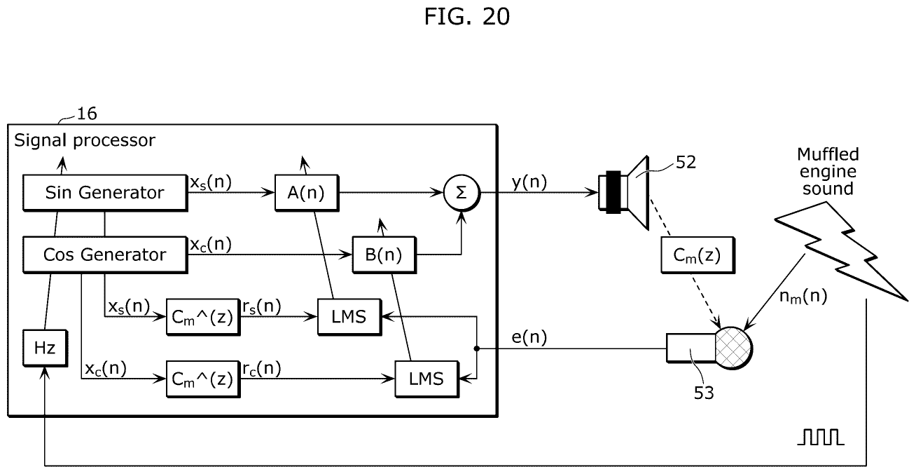

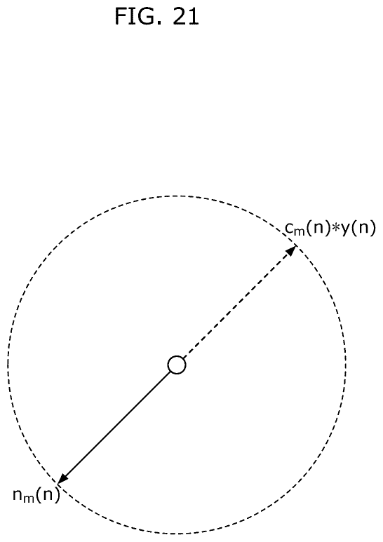

Next description is given regarding a noise reduction method using the SAN filtered-x LMS algorithm executed by signal processor 16. FIG. 20 is a block diagram showing a functional configuration of an active noise reduction device that conforms to the SAN filtered-x LMS algorithm. FIG. 21 is a diagram showing the relation between the second noise and the cancellation sound in the SAN filtered-x LMS algorithm. In the following description of the noise reduction method using the SAN filtered-x LMS algorithm, the second noise is assumed to be a muffled engine sound. The muffled engine sound is noise that is instantaneously approximate to a sinusoidal wave with a single frequency.

The cancellation signal propagates through the loudspeaker, the cabin space, and the microphone and is input to the active noise reduction device. This signal transduction pathway is expressed as sound transfer function cₘ(z), where z means z-transformation. The SAN filtered-x LMS algorithm is an algorithm based on the above-described SAN algorithm that takes sound transfer function cₘ(z) into consideration. In FIGS. 20 and 21, simulated sound transfer function Cₘ\hat{ }(z) represents the transfer function (filter) that simulates sound transfer function Cₘ(z). Here, nm (n) denotes the muffled engine sound with frequency f₀[Hz] at the position of the microphone, cₘ(n) denotes the impulse response of the discrete time n of cₘ(z), cₘ(n)*y(n) represents the cancellation sound at the position of the microphone, and * means the convolution operator. In the case of actually reducing the muffled engine sound, the convolution corresponds to the integral of continuous times, but in the following description, the convolution is assumed as a product-sum operation.

In the noise reduction method based on the SAN filtered-x LMS algorithm, filter coefficients A(n) and B(n) converge to optimum values as a result of repeated execution of processing described in (1) to (5) below.
(1) Frequency f₀[Hz] of muffled engine sound nm (n) is detected based on a signal indicating the rotational frequency of the engine.
(2) Sinusoidal wave xₛ(n) and cosine wave x_{c}(n) with frequency f₀[Hz] are generated, multiplied by coefficients A(n) and B(n), and added to generate cancellation signal y(n) expressed by Expression 4.

$$y ( n ) = A ( n ) {X}_{S} ( n ) + B ( n ) {X}_{C} ( n ) \qquad [ Expression 4 ]$$

(3) A cancellation sound is output from the loudspeaker in accordance with cancellation signal y(n). Residual sound (error signal) e(n) caused by interference between cancellation sound cₘ(n)*y(n) and muffled engine sound nm (n) is detected by the microphone at the position of the microphone.
(4) Each of sinusoidal wave xₛ(n) and cosine wave x_{c}(n) is filtered by cₘ\hat{ }(z) to generate sinusoidal wave rₛ(n) and cosine wave r_{c}(n).
(5) Filter coefficients A(n) and B(n) are updated in accordance with LMS-update formulas expressed by Expressions 5 and 6. Note that μ denotes the step-size parameter that determines the amount of update (the rate of update) of filter coefficients A(n) and B(n) per sampling unit.

$$A ( n + 1 ) = A ( n ) - μ {r}_{S} ( n ) e ( n ) \qquad [ Expression 5 ]$$

$$B ( n + 1 ) = B ( n ) - μ {r}_{C} ( n ) e ( n ) \qquad [ Expression 6 ]$$

Here, additional information is given about the muffled engine sound. The muffled engine sound refers to noise that is generated inside space 57 of the cabin when vibrations and exhaust noise caused by explosions in the process of air aspiration, compression, explosions, and exhaust of the engine propagate through a chassis or the like of vehicle 50. For example, in the case where the engine is a four-cylinder four-cycle engine, two revolutions of the shaft cause explosions in all of the four cylinders, and two explosions occur per revolution. This produces noise having a frequency component that is double the engine rotational frequency. This noise may be called, for example, secondary muffled sound (secondary component) of the engine revolutions and may pose a problem due to a higher noise level of the secondary component than the noise level of the other components. Not only the secondary component but also a high harmonic component may pose a problem.

In the case where the engine is a six-cylinder engine, a tertiary component has a high noise level, and in the case where the engine is a three-cylinder engine, a 1.5-order component has a high noise level. That is, if the number of cylinders in the engine is reduced by downsizing, the muffled engine sound will have a lower dominant frequency.

### Correction of Simulated Sound Transfer Function in SAN Filtered-x LMS Algorithm

As shown in FIG. 17 described above, signal processor 16 receives input of the detection signal output from seat position detector 55. Thus, signal processor 16 may correct the phase of cₘ\hat{ }(z) according to the adjustment state of seat 54 indicated by the detection signal. The correction of the phase of cₘ\hat{ }(z) may be implemented by using the table information stored in advance in the same manner as in the method described with reference to FIGS. 7 and 8, or may be implemented in accordance with an algorithm in the same manner as disclosed in PTL 2. Signal processor 16 may also correct the gain of cₘ\hat{ }(z) in addition to the phase of cₘ\hat{ }(z).

### Advantageous Effects

Inventive techniques derived from the disclosure of the present specification may, for example, be the following techniques. Hereinafter, the inventive techniques derived from the disclosure of the present specification are described in combination with advantageous effects achieved by these inventive techniques.

Technique 1 is active noise reduction device 10 that reduces noise at the position of microphone 53 installed in seat 54 whose position or orientation is adjustable, by outputting a cancellation sound from loudspeaker 52 inside space 57 of a mobile object. Active noise reduction device 10 includes storage 12 that stores an impulse response with a first sampling rate, the impulse response simulating a sound transfer characteristic ranging from loudspeaker 52 to microphone 53 while the adjustment state of seat 54 is a reference position; adaptive filter part 11 that generates a cancellation signal that is used to output a cancellation sound, by applying an adaptive filter to a reference signal that is correlated with noise and that is output from reference signal source 51 provided in the mobile object; simulated sound transfer characteristic generator 13 that generates a simulated sound transfer characteristic by acquiring the adjustment state of seat 54, shifting the impulse response in a time-base direction according to the acquired adjustment state of seat 54, and downsampling the shifted impulse response from the first sampling rate to a second sampling rate; simulated sound transfer characteristic filter part 14 that generates a filtered reference signal by correcting the reference signal in accordance with the generated simulated sound transfer characteristic; and filter coefficient updater 15 that updates a coefficient of the adaptive filter by using the generated filtered reference signal and an error signal that is output from microphone 53 and that corresponds to a residual sound caused by interference between the noise and the cancellation sound. The mobile object may, for example, be vehicle 50 according to the above-described embodiment.

Active noise reduction device 10 as described above generates the simulated sound transfer characteristic according to the adjustment state of seat 54 provided with microphone 53 (i.e., a change in the sound transfer characteristic). This improves noise reduction performance when the sound transfer characteristic varies.

Technique 2 is active noise reduction device 10 according to Technique 1, in which active noise reduction device 10 outputs a cancellation sound not only from the first loudspeaker serving as loudspeaker 52 but also from a second loudspeaker different from the first loudspeaker by using a fixed simulated sound transfer characteristic irrespective of the adjustment state of seat 54. The first loudspeaker is a loudspeaker for reducing noise in a frequency band higher than or equal to a predetermined boundary frequency, and the second loudspeaker is a loudspeaker for reducing noise in a frequency band lower than the predetermined boundary frequency.

Active noise reduction device 10 as described above narrows down the loudspeakers that output the cancellation sound by using the simulated sound transfer characteristic that depends on the adjustment state of seat 54, from the first and second loudspeakers to only the first loudspeaker. This allows efficient noise reduction.

Technique 3 is active noise reduction device 10 according to Technique 1 or 2, in which simulated sound transfer characteristic generator 13 generates the simulated sound transfer characteristic by shifting the impulse response in the time-base direction according to the acquired adjustment state of seat 54, downsampling the shifted impulse response from the first sampling rate to the second sampling rate, and further multiplying the downsampled impulse response by a gain that depends on the acquired adjustment state of seat 54.

Active noise reduction device 10 as described above generates the simulated sound transfer characteristic in consideration of not only the phase but also the gain. This further improves noise reduction performance when the sound transfer characteristic varies.

Technique 4 is active noise reduction device 10 according to any one of Techniques 1 to 3, in which when the acquired adjustment state of seat 54 deviates from a predetermined range, active noise reduction device 10 stops the output of the cancellation sound from loudspeaker 52.

By stopping the output of the cancellation sound, active noise reduction device 10 as described above can reduce the possibility that the cancellation sound may become an unusual sound.

Technique 5 is active noise reduction device 10 according to any one of Techniques 1 to 3, in which when the acquired adjustment state of seat 54 deviates from the predetermined range, active noise reduction device 10 limits the output of the cancellation sound from loudspeaker 52.

By limiting the output of the cancellation sound, active noise reduction device 10 can reduce the possibility that the cancellation sound may become an unusual sound.

Technique 6 is active noise reduction device 10 according to Technique 4 or 5, in which the adjustment state of seat 54 includes the adjustment state of the backrest angle of seat 54, and when the backrest angle of the seat at the reference position is zero and the backrest angle at which the backrest of the seat tilts backward is a positive angle, the predetermined range for the backrest angle is greater than or equal to −20° and less than or equal to +45°.

By stopping the output of the cancellation sound or limiting the output when the backrest angle of seat 54 deviates from the range that is greater than or equal to −20° and less than or equal to +45°, active noise reduction device 10 as described above can reduce the possibility that the cancellation sound may become an unusual sound.

Technique 7 is active noise reduction device 10 according to Technique 4 or 5, in which the adjustment state of seat 54 includes the adjustment state of the back-and-forth position of seat 54, and when the back-and-forth position of seat 54 at the reference position is 0, the predetermined range for the back-and-forth position of seat 54 is greater than or equal to −10 cm and less than or equal to +10 cm.

By stopping the output of the cancellation sound or limiting the output when the back-and-forth position of seat 54 deviates from the range that is greater than or equal to −10 cm and less than or equal to +10 cm, active noise reduction device 10 can reduce the possibility that the cancellation sound may become an unusual sound.

Technique 8 is active noise reduction device 10 according to any one of Techniques 1 to 7, in which the adjustment state of seat 54 includes at least one of the adjustment state of the backrest angle of seat 54, the adjustment state of the back-and-forth position of seat 54, or the adjustment state of the position of seat 54 in the height direction.

Active noise reduction device 10 as described above generates the simulated sound transfer characteristic according to at least one of the adjustment state of the backrest angle of seat 54, the adjustment state of the back-and-forth position of seat 54, or the adjustment state of the position of seat 54 in the height direction. This improves noise reduction performance when the sound transfer characteristic varies.

Technique 9 is active noise reduction device 10 (active noise reduction device 10a) according to any one of Techniques 1 to 8 that further includes signal processor 16 that receives, as input signals, the error signal and the reference signal correlated with the second noise different from first noise serving as the above-described noise, and outputs, to loudspeaker 52, the cancellation signal for reducing the second noise in accordance with the single frequency adaptive notch (SAN)-filtered-x least mean square (LMS) algorithm.

Active noise reduction device 10 as described above can reduce the second noise in addition to the first noise.

Technique 10 is a mobile object that includes active noise reduction device 10 according to any one of Techniques 1 to 9, loudspeaker 52, microphone 53, and seat 54.

The mobile object as described above generates the simulated sound transfer characteristic according to the adjustment state of seat 54 provided with microphone 53 (i.e., a change in the sound transfer characteristics). This improves noise reduction performance when the sound transfer characteristic varies.

Technique 11 is an active noise reduction method that is executed by active noise reduction device 10 that reduces noise at the position of microphone 53 provided at seat 54 whose position or orientation is adjustable, by outputting the cancellation sound from loudspeaker 52 inside space 57 of the mobile object. Active noise reduction device 10 includes storage 12 that stores the impulse response with the first sampling rate, the response simulating the sound transfer characteristic ranging from loudspeaker 52 to microphone 53 when the adjustment state of seat 54 is the reference position. The active noise reduction method includes step S12 of generating the cancellation signal that is used to output the cancellation sound, by applying the adaptive filter to the reference signal that is correlated with the noise and that is output from reference signal source 51 provided in the mobile object; step S15 of generating the simulated sound transfer characteristic by acquiring the adjustment state of seat 54 relative to the position of microphone 43, shifting the impulse response in the time-base direction according to the acquired adjustment state of seat 54, and downsampling the shifted impulse response from the first sampling rate to the second sampling rate; step S16 of generating the filtered reference signal by correcting the reference signal in accordance with the generated simulated sound transfer characteristic; and step S17 of updating the coefficient of the adaptive filter by using the generated filtered reference signal and the error signal that is output from microphone 53 and that corresponds to the residual sound caused by interference between the noise and the cancellation sound.

The active noise reduction method as described above involves generating the simulated sound transfer characteristic according to the adjustment state of seat 54 provided with microphone 53 (i.e., a change in the sound transfer characteristic). This improves noise reduction performance when the sound transfer characteristic varies.

### Other Embodiments

While one embodiment has been described thus far, the present disclosure is not intended to be limited to the above-described embodiment.

For example, the active noise reduction device according to the above-described embodiment may be installed in a mobile object other than a vehicle. The mobile object may, for example, be an airplane or a marine vessel. Moreover, the present disclosure may be realized as a mobile object other than such vehicles.

The configuration of the active noise reduction device according to the above-described embodiment is merely one example. For example, the active noise reduction device may include constituent elements such as a digital-to-analog (D/A) converter, a low-pass filter (LPF), a high-pass filter (HPF), a power amplifier, or an A/D converter.

The processing performed by the active noise reduction device according to the above-described embodiment is merely one example. For example, part of the processing described in the above embodiment may be realized by analog signal processing, instead of digital signal processing.

In the above-described embodiment, for example, processing executed by a specific processing unit may be executed by a different processing unit. Moreover, a sequence of a plurality of processing steps may be modified, or a plurality of processing steps may be executed in parallel.

It is to be noted that general or specific aspects of the present disclosure may be realized as a system, a device, a method, an integrated circuit, a computer program, or a non-transitory recording medium such as a computer-readable CD-ROM. The present disclosure may also be realized by any combination of a system, a device, a method, an integrated circuit, a computer program, and a non-transitory computer-readable recording medium.

For example, the present disclosure may be realized as a noise reduction method that is executed by a computer such as an active noise reduction device (DSP), or may be realized as a program for causing a computer (DSP) to execute the active noise reduction method. The present disclosure may also be realized as a noise reduction system that includes the active noise reduction device according to the above-described embodiment, a loudspeaker (sound output device), and a microphone (sound-collecting device).

The sequence of a plurality of processing steps in the operation performed by the active noise reduction device according to the above-described embodiment is merely one example. The sequence of a plurality of processing steps may be modified, or may be executed in parallel.

The present disclosure also includes other variations obtained by making various changes conceivable by a person skilled in the art to the embodiment, and variations obtained by any combination of the constituent elements and functions of the embodiment without departing from the scope of the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2024-108354 filed on Jul. 4, 2024.

### INDUSTRIAL APPLICABILITY

The active noise reduction device according to the present disclosure may be used as, for example, a device that reduces noise in the cabin of a vehicle.

1. An active noise reduction device that reduces noise at a position of a microphone provided at a seat whose position or orientation is adjustable, by outputting a cancellation sound from a loudspeaker in an inner space of a mobile object, the active noise reduction device comprising:
a storage that stores an impulse response with a first sampling rate, the impulse response simulating a sound transfer characteristic ranging from the loudspeaker to the microphone when an adjustment state of the seat is a reference position;
an adaptive filter part that generates a cancellation signal that is used to output the cancellation sound, by applying an adaptive filter to a reference signal that is correlated with the noise and that is output from a reference signal source provided in the mobile object;
a simulated sound transfer characteristic generator that generates a simulated sound transfer characteristic by acquiring the adjustment state of the seat relative to the position of the microphone, shifting the impulse response in a time-base direction according to the adjustment state of the seat acquired, and downsampling the impulse response shifted, from the first sampling rate to a second sampling rate;
a simulated sound transfer characteristic filter part that generates a filtered reference signal by correcting the reference signal in accordance with the simulated sound transfer characteristic generated; and
a filter coefficient updater that updates a coefficient of the adaptive filter by using the filtered reference signal generated and an error signal that is output from the microphone and that corresponds to a residual sound caused by interference between the noise and the cancellation sound.

2. The active noise reduction device according to claim 1,
wherein the active noise reduction device outputs the cancellation sound not only from a first loudspeaker serving as the loudspeaker but also from a second loudspeaker different from the first loudspeaker by using a fixed simulated sound transfer characteristic irrespective of the adjustment state of the seat,
the first loudspeaker is a loudspeaker for reducing noise in a frequency band higher than or equal to a predetermined boundary frequency, and
the second loudspeaker is a loudspeaker for reducing noise in a frequency band lower than the predetermined boundary frequency.

3. The active noise reduction device according to claim 1,
wherein the simulated sound transfer characteristic generator generates the simulated sound transfer characteristic by shifting the impulse response in the time-base direction according to the adjustment state of the seat acquired, downsampling the impulse response shifted, from the first sampling rate to the second sampling rate, and further multiplying the impulse signal downsampled, by a gain that depends on the adjustment state of the seat acquired.

4. The active noise reduction device according to claim 1,
wherein when the adjustment state of the seat acquired deviates from a predetermined range, the active noise reduction device stops output of the cancellation sound from the loudspeaker.

5. The active noise reduction device according to claim 1,
wherein when the adjustment state of the seat acquired deviates from a predetermined range, the active noise reduction device limits output of the cancellation sound from the loudspeaker.

6. The active noise reduction device according to claim 4,
wherein the adjustment state of the seat includes an adjustment state of a backrest angle of the seat, and
when the backrest angle of the seat at the reference position is zero and the backrest angle at which a backrest of the seat tilts backward is a positive angle, the predetermined range for the backrest angle is greater than or equal to −20° and less than or equal to +45°.

7. The active noise reduction device according to claim 4,
wherein the adjustment state of the seat includes an adjustment state of a back-and-forth position of the seat, and
when the back-and-forth position of the seat at the reference position is zero, the predetermined range for the back-and-forth position of the seat is greater than or equal to −10 cm and less than or equal to +10 cm.

8. The active noise reduction device according to claim 1,
wherein the adjustment state of the seat includes at least one of an adjustment state of a backrest angle of the seat, an adjustment state of a back-and-forth position of the seat, or an adjustment state of a position of the seat in a height direction.

9. The active noise reduction device according to claim 1, further comprising:
a signal processor that receives, as input signals, the error signal and a reference signal that is correlated with second noise different from first noise serving as the noise, and outputs, to the loudspeaker, a cancellation signal for reducing the second noise in accordance with a single frequency adaptive notch filter (SAN) filtered-x least mean square (LMS) algorithm.

10. A mobile object comprising:
the active noise reduction device according to claim 1;
the loudspeaker;
the microphone; and
the seat.

11. An active noise reduction method that is executed by an active noise reduction device that reduces noise at a position of a microphone provided at a seat whose position or orientation is adjustable, by outputting a cancellation sound from a loudspeaker in an inner space of a mobile object,
the active noise reduction device including a storage that stores an impulse response with a first sampling rate, the impulse response simulating a sound transfer characteristic ranging from the loudspeaker to the microphone when an adjustment state of the seat is a reference position,
the active noise reduction method comprising:
generating a cancellation signal that is used to output the cancellation sound, by applying an adaptive filter to a reference signal that is correlated with the noise and that is output from a reference signal source provided in the mobile object;
generating a simulated sound transfer characteristic by acquiring the adjustment state of the seat relative to the position of the microphone, shifting the impulse response in a time-base direction according to the adjustment state of the seat, and downsampling the impulse response shifted, from the first sampling rate to a second sampling rate;
generating a filtered reference signal by correcting the reference signal in accordance with the simulated sound transfer characteristic generated; and
updating a coefficient of the adaptive filter by using the filtered reference signal generated and an error signal that is output from the microphone and that corresponds to a residual sound caused by interference between the noise and the cancellation sound.
